(19) United States
(12) Patent Application Publication
(10) Pub. No.: US 2002/0089412 A1
(43) Pub. Date: Jul. 11, 2002

(54) Control system with user authentication

(75) Inventors: Hans Jorg Heger, Munchen (DE); Wolfgang Kupper, Munchen (DE)

Correspondence Address: STAAS & HALSEY LLP, 700 11TH STREET, NW, SUITE 500, WASHINGTON, DC, 20001, US

(73) Assignee: Siemens Aktiengesellschaft, Munich (DE)

(21) Appl. No.: 10/035,326

(22) Filed: Jan. 4, 2002

(30) Foreign Application Priority Data
Jan. 9, 2001 (DE) 10100617.9

(51) Int. Cl. H04Q 1/00

(52) U.S. Cl. 340/5.82

(57) ABSTRACT

A controllable arrangement which can be controlled by contactless sensing of a body part and/or object arranged on it and in which authentication of a user takes place by of a body part is characterized in that the arrangement can be controlled by at least a part of a limb and the user can be authenticated by at least of a limb.

### CROSS REFERENCE TO RELATED APPLICATIONS

This application is based on and hereby claims priority to German Application No. 10100617.9 filed on Jan. 9, 2001 in Germany, the contents of which are hereby incorporated by reference.

### BACKGROUND OF THE INVENTION

The invention relates to a device which can be controlled by contactless sensing of a body part and/or an object arranged on it and in which authentication of a user takes place by a body part, and relates to a corresponding method and computer program.

In human-machine interaction, ways which correspond to natural human communication are being increasingly adopted. Data processing systems are no longer only gray boxes which are issued commands via a keyboard or mouse, but are increasingly integrated into the surroundings and register commands via sensor systems.

One embodiment of this is gesture-controlled computers, which respond to human movements. For this purpose, a body part or an object arranged on it, or its movements and gestures, are contactlessly sensed. Lips or a hand are examples of the body part. In the latter case specifically, it does not necessarily have to be the hand itself that is contactlessly sensed, but instead the sensing of a object arranged on it, for example in the form of a pointer or a reflective glove, is also sufficient. Systems of this type are described, for example, in U.S. Pat. No. 5,533, 177,751,843, 5,828,779, EP 560779 B1, EP0 713 592, B1, EP 0 800 145 A2 and WO 98/138533.

In these systems, for example in the case of a presentation with a projector, the control of the presentation is made possible by gestures, which the system records and are evaluated by a data processing system belonging to the arrangement.

Another field of development is the improvement of the methods of authentication for the user of a controllable system. For many computer applications, authentication of the user is expected and this is generally achieved by entering a password or a PIN via a numeric array or a keypad. More recent developments are the biometric methods. They use characteristic body features and types of behavior for user authentication.

For instance, there is a known system in which a biometric personal identification system authenticates the user on the basis of the face, voice and characteristic lip movement.

On this basis, the one possible object of the invention is to extend the control and authentication capabilities of systems.

### SUMMARY OF THE INVENTION

This object is achieved by a system, a method and a program product with the features of the independent claims.] The control of the system and the authentication of the user takes place by the human limbs. In this case, it is not necessarily the full limbs, that is arms and legs including hands and feet, that have to be used, but instead parts thereof which have adequate functionality for control purposes or adequate characteristics for authentication purposes are also sufficient.

A series of advantages are obtained if the part of the limb by which the system can be controlled is located on the same limb as the part of the limb by which the user can be authenticated. Preferably, the two parts are even partly or completely identical. This is because the user then only needs to come into interaction with the system with this part of a limb and, conversely, the system needs only to sense this part of a limb.

In particular, the system is designed such that the part of a limb is a hand. This is because humans are accustomed to controlling systems with the hand, for which reason the hand also has correspondingly high functionality.

Furthermore, the authentication may be performed on the basis of a hand recognition. To realize the hand recognition, it is possible to resort to the extensive prior art available for hand recognition.

In keeping with the objective of achieving natural control of the system, the system is set up in such a way that it can identify gestures of the user and be controlled by them. Such gestures may be, for example, pointing movements of the part of a limb with which the system is contactlessly controllable, but also turning movements or holding of the part of a limb in a quite specific manner.

Instead of or in addition to the control of the system, the identification of a gesture may also be used for the authentication of the user. For this purpose, the user is recognized in particular from a specific gesture, known only to him, or it is detected that the user is performing the gesture in a quite specific manner, in a way not generally adopted by other users.

For the contactless control and authentication of the user, the system has a recorder for recording at least one of the parts of a limb. The recordings produced in this way are passed on to a data processing system and processed there, to permit the control and authentication.

The recorder preferably has a sensor to sense electromagnetic waves or sound waves. If the recorder is designed for example as a video camera, such a sensor can be realized by a CCD chip.

It is particularly preferred if the system has a recorder of the same type for recording the part of a limb by which the system can be controlled and for the part of a limb by which the user can be authenticated. A recorder of the same type is intended to mean in this context that the recorder belong to the same generic type of device, that is, for example, they are in each case video cameras. A configuration with recorders of the same type also has the effect that data records of the same type are generated, which significantly simplifies the further processing for control and authentication in a data processing system.

Even though video cameras can in the meantime be provided at very low cost, further costs can be saved if the same recorder is used for the authentication and the control.

In the case of a method for controlling an system and for authenticating a user of the system, in which the system is controlled by contactless sensing of a body part and/or an object arranged on it and in which the authentication of the user takes place by a body part, the system is contactlessly controlled by at least a part of a limb and the user is authenticated by at least a part of a limb.

The above advantages for the control system are also present for the corresponding method, with the result that the method can be advantageously implemented by applying the features described. A computer program for a data processing system which contains software code sections with which one of the methods described can be executed on the data processing system can be run by suitable implementation of the method in a programming language. The software code sections are stored for this purpose. In this case, a computer program is understood as meaning the program of a tradeable product. It may take any desired form, such as for example on paper, a computer-readable data medium or distributed over a network.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a controllable system with a user, who is authenticated by a part of a limb, and

FIG. 2 shows the controllable system with the user while the latter is controlling the system with the part of a limb.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

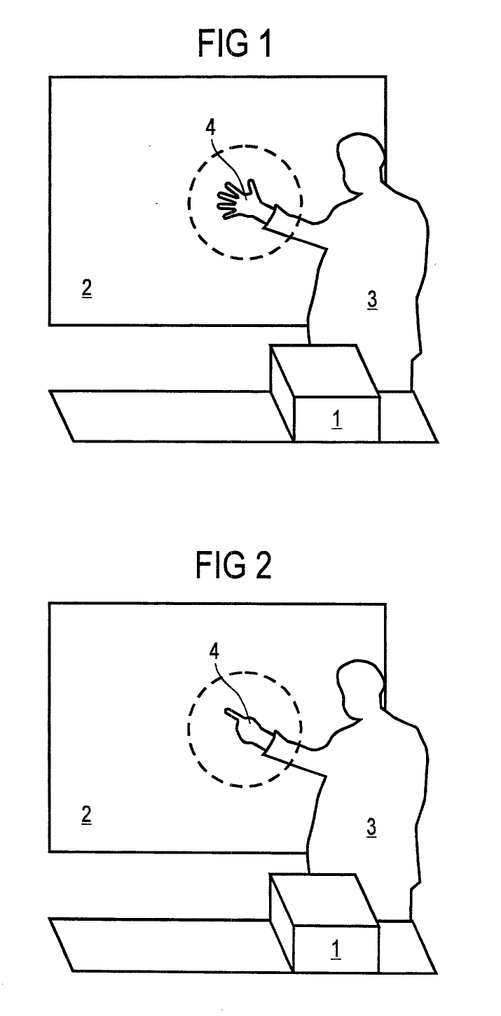

In FIG. 1, a controllable system 1 can be seen. This includes a projector, with which an image is projected onto an interaction surface 2. Furthermore, it includes an infrared light source, with which light is emitted in the direction of the interaction surface 2. The interaction surface 2 is made to be retroreflective, with the result that the infrared light is reflected to a high degree.

A user 3 acting in front of the retroreflective interaction surface 2 casts a shadow on certain regions of the retroreflective interaction surface 2. In the region of the retroreflective interaction surface 2 cast in shadow by the user, much less infrared light is reflected to the control system 1.

The control system 1 also has a recorder with a sensor for electromagnetic radiation in the form of a video camera with a CCD chip. Arranged in front of the recorder is an infrared filter, with the result that essentially only infrared radiation reflected by the interaction surface 2 to the control system 1 is recorded. As a result, influences induced by the ambient light are eliminated to the greatest extent. Consequently, the recorder of the control system 1 essentially record a shadow image of the user 3 located in front of the interaction surface 2.

This image is passed on by the recorder to a data processing system, which for its part is part of the control system 1. The data processing system evaluates by using an image processing operation the digital image data recorded by the recorder. For this purpose, the position of the part 4 of a limb in front of the interaction surface 2, serving for controlling the controllable system 1 and/or for authenticating the user 3, is initially determined.

In the exemplary embodiment presented, the part 4 of a limb is a hand and the limb itself is an arm.

Once the position of the part 4 of a limb has been determined, characteristic features are extracted from the image of the part 4 of a limb, and in particular from its contour, in a segmentation process. In this process, the wrist, the palm and the fingers of the hand are also taken into consideration in particular. The characteristic features are compared with the characteristic features stored in a training phase of one or more persons which can be authenticated and, if there is an adequate match, the user 3 is authenticated. The authentication may be a verification or an identification.

After the authentication, or independently of it, the user 3 can, as presented in FIG. 2, control the controllable device 1 by gestures, which he performs in front of the interaction surface 2. For this purpose, the interaction surface 2 is further irradiated with infrared light by the control system 1 and the inverse image of the user 3 is recorded by the recorder of the control system 1. The image is passed on to the data processing system of the control system 1 and evaluated there.

The control of the control system 1 by the user 3 takes place by gestures. For instance, the user 3 can point at different elements which are projected onto the interaction surface 3 by the projector of the control system 1. By pointing at these elements, and possibly by further actions, such as for example dwelling briefly over one of these elements, actions associated with the elements are initiated and the control system 1 is controlled as a result.

Control of the controllable system 1 by the user 3 can also take place even before the authentication of the user 3. For instance, a gesture for calling up the authentication, by which the authentication process described above is called up and initiated, may be provided in particular. Once these gestures for calling up the authentication have been performed, the authentication of the user 3 by the control system 1 takes place.

Furthermore, with the described form of the controllable system 1 and of the method for controlling this system, a detection of life can be implemented very simply, by detecting whether a limb, and in particular the part 4 of the limb, is moving. It is preferred in this case for a movement in itself to be detected. For instance, authentication by simple immovable copies of a body part of the user 3 is ruled out.

With the above described system and method the user can communicate with the system in a quite intuitive way, that is literally with hands and feet. The interaction in this case concerns both the authentication and the control of the control system.

The invention has been described in detail with particular reference to preferred embodiments thereof and examples, but it will be that variations and modifications can be effected within the spirit and scope of the invention. understood that variations and modifications

What is claimed is:

1. A control system comprising:
a contactless sensor to sense at least one object selected from a body part and an object arranged on the body part;
an authentication device to authenticate a user based on a sensed object; and
a controller to control a device based on a sensed object.

2. The control system as claimed in claim 1, wherein the sensed object for authentication is the same as the sensed object for control.

3. The control system as claimed in claim 1, wherein at least one of the sensed object for authentication and the sensed object for control is a hand.

4. The control system as claimed in at least claim 3, wherein the sensed object for authentication is a hand and the authentication device includes a hand recognition device.

5. The control system as claimed in claim 1, wherein the sensor can identify gestures of the user.

6. The control system as claimed in claim 5, wherein the device is controlled by the gestures.

7. The control system as claimed in claim 5, wherein the user is authenticated by the gestures.

8. The control system as claimed in claim 1, further comprising a recorder for recording at least one of the object used for authentication and the object used for control.

9. The control system as claimed in claim 8, wherein the recorder has a sensor for electromagnetic waves or sound waves.

10. The control system as claimed in claim 8, wherein the system has a first recorder for recording the object used for authentication and a second recorder for recording the object used for control, wherein the first and second recorders are the same type of recorders.

11. The control system as claimed in claim 8, wherein
the same recorder is used both for control and authentication, and
a recording of the recorder is evaluated both for control and authentication.

12. The control system as claimed in claim 2, wherein at least one of the sensed object for authentication and the sensed object for control is a hand.

13. The control system as claimed in at least claim 12, wherein the sensed object for authentication is a hand and the authentication device includes a hand recognition device.

14. The control system as claimed in claim 13, wherein the sensor can identify gestures of the user.

15. The control system as claimed in claim 14, wherein the device is controlled by the gestures.

16. The control system as claimed in claim 15, wherein the user is authenticated by the gestures.

17. The control system as claimed in claim 16, the further comprising a recorder for recording at least one of the object used for authentication and the object used for control.

18. The control system as claimed in claim 17, wherein the recorder has a sensor for electromagnetic waves or sound waves.

19. The control system as claimed in claim 18, wherein the system has a first recorder for recording the object used for authentication and a second recorder for recording the object used for control, wherein the first and second recorders are the same type of recorders.

20. The control system as claimed in claim 18, wherein
the same recorder is used both for control and authentication, and
a recording of the recorder is evaluated both for control and authentication.

21. A method to control a device and authenticate a user, comprising:
sensing at least one object selected from a body part and an object arranged on the body part, using contactless sensing;
authenticating the user based on a sensed object; and
controlling the device based on a sensed object.

22. A computer readable medium storing a program to control computer to perform a method comprising:
sensing at least one object selected from a body part and an object arranged on the body part, using contactless sensing;
authenticating a user based on a sensed object; and
controlling a device based on a sensed object.
